(19) United States
(12) Patent Application Publication
(10) Pub. No.: US 2025/0361158 A1
(43) Pub. Date: Nov. 27, 2025

(54) FLOATING CARRIER FOR WATER HEAVY METAL REMOVAL REAGENTS AND METHOD FOR REMOVING HEAVY METALS FROM WATER

(71) Applicants: Shanghai Chemical Industry Design Institute Environmental Engineering Co., Ltd., Shanghai (CN); Shanghai Research Institute of Chemical Industry CO., LTD, Shanghai (CN)

(72) Inventors: Changbo Zhang, Shanghai (CN); Jintao Yu, Shanghai (CN); Xiaoyu Ma, Shanghai (CN); Xiaoyong Tang, Shanghai (CN); Guilan Yang, Shanghai (CN); Yuning Xuan, Shanghai (CN); Shubo Tan, Shanghai (CN); Jing Cen, Shanghai (CN); Tingkai Wang, Shanghai (CN)

(21) Appl. No.: 18/894,009

(22) Filed: Sep. 24, 2024

(30) Foreign Application Priority Data
May 24, 2024 (CN) 202410654366.4

(51) Int. Cl. C02F 1/28; B01D 15/10; C02F 101/20

(52) U.S. Cl. CPC C02F 1/281; B01D 15/10; C02F 2101/20; C02F 2201/007; C02F 2201/008; C02F 2301/04

(57) ABSTRACT

A floating carrier for water heavy metal removal reagents includes a carrier floating cover, an outer bracket, an inner bracket, multiple reagent filter cylinders, water flow channels, a microfluidic channel and micro channels. The carrier floating cover is a hollow shell structure and configured to provide buoyancy in the water. The reagent filter cylinders are respectively disposed in carrying positions, and are configured to accommodate and support the heavy metal removal reagents. Each water flow channel is defined in a middle part of the outer bracket with a venturi tube structure and configured to guide water flow through the floating carrier. The microfluidic channel is defined within the outer bracket and connected to the water flow channels and the micro channels. The floating carrier has characteristics of simple form, large reagent contact area and anti-fouling, meeting needs of heavy metal remediation in the water.

### CROSS-REFERENCE TO RELATED APPLICATION

This application claims priority to Chinese Patent Application No. 202410654366.4, filed May 24, 2024, which is herein incorporated by reference in its entirety.

### TECHNICAL FIELD

The disclosure relates to the field of environmental protection technology for heavy metal remediation in water, and more particularly to a floating carrier for water heavy metal removal reagents and a method for removing heavy metals from water.

### BACKGROUND

How to efficiently and inexpensively remove heavy metals from paddy soils currently become a hot spot and difficulty. Currently, heavy metal treatment technologies in the paddy soils, rivers, and waterways mostly adopt industrial site pollution control technologies, which require large investments and are prone to secondary pollution. The development of biotechnology for the heavy metal treatment is not mature enough, and there are still problems such as a long treatment period. Since rice growth requires a large amount of irrigation water, the soil washing remediation technology implemented in conjunction with irrigation may become a rapid, efficient, and low-cost technology for remediating heavy metal-contaminated paddy soil.

Currently, there are few records of remediation agent carriers in the related art. Carriers used in engineering are mainly chemical filler carriers, which generally have problems such as poor resistance to pollution and weak reusability. At the same time, records in literature are mostly about wrapping remediation agents with filter meshes, which also have problems such as poor resistance to pollution.

A Chinese patent with publication No. 202210741043.X proposes “A nano sponge loaded phosphate modified chitosan composite material, preparation method and application”. The preparation method includes the following steps: 1, chitosan/polyvinyl alcohol is weighed and added to deionized water followed by stirring at a set temperature to obtain a sol at a set ratio; 2, at room temperature, a 0.5×0.5×0.5 centimeters (cm) square nano sponge is immersed in the chitosan/polyvinyl alcohol sol prepared in the step 1 for a set time, and then hardened in a set concentration of sodium hydroxide solution for a set time, followed by separating and washing to obtain the nano sponge loaded chitosan composite material, and the nano sponge loaded chitosan composite material in is immersed tetrakis(hydroxymethyl)phosphonium sulfate (THPS) for a set time. This invention has advantages of low cost, simple operation, and reagents can be easily recovered and reused. However, the sponge is prone to be contaminated by other pollutants when used in water due to its non-selectivity.

A Chinese patent with publication No. 202120117141.7 proposes “An efficient adsorption wastewater treatment carrier”, which includes a first outer fixed frame, an inner side of the first outer fixed frame is fixedly installed with eight first fixed brackets. The efficient adsorption wastewater treatment carrier utilizes a first wastewater treatment component, a second wastewater treatment component and a third wastewater treatment component which are uniformly distributed to increase a contact area between the device and wastewater. Activated carbon and nano particle loaded polyurethane porous hydrogel have characteristics of filtration, adsorption and nano particle physicochemical effect, increasing ability of the device to treat wastewater. Bolts on the outside of a first installation block and a second installation block are dismantled, a first wastewater treatment carrier is drawn out from between the first outer fixed frame and a second fixed bracket, bolts on the outside of a third installation block and a fourth installation block are dismantled, and a third wastewater treatment carrier is drawn out from between the second outer fixed frame and a third fixed bracket. The operation is simple, an overall structure is compact with reasonable design and use convenience. During a use process of this device, it is unable to remove pollutant particles on the outer surface, and adsorption capacity is greatly affected by sludge and other particles during the use process.

### SUMMARY

A purpose of the disclosure is to provide a floating carrier for water heavy metal removal reagents and a method for removing heavy metals from the water which are simple and efficient, to overcome shortcomings in the related art.

The purpose of the disclosure can be achieved by below technical solutions.

In a first aspect, the disclosure provides the floating carrier for the water heavy metal removal reagents. The floating carrier includes a carrier floating cover, an outer bracket, an inner bracket, multiple reagent filter cylinders, water flow channels, a microfluidic channel and micro channels. Specifically, the carrier floating cover is a hollow shell structure and configured to provide buoyancy in the water. The outer bracket is disposed below the carrier floating cover. The inner bracket is disposed in the outer bracket and defines multiple carrying positions. The reagent filter cylinders are respectively disposed in the carrying positions, and the reagent filter cylinders are configured to accommodate and support the water heavy metal removal reagents. The water flow channels are defined in a middle part of the outer bracket, and each water flow channel is a venturi tube structure and configured to guide water flow through the floating carrier. The microfluidic channel is defined within the outer bracket, and the microfluidic channels are connected to the water flow channels and configured to form a negative pressure water absorption condition to allow water in the microfluidic channels to be sucked into the water flow channels. The micro channels are defined on the inner bracket and are connected to the microfluidic channels to allow part of water in the reagent filter cylinders to be sucked into the micro channels and enter the microfluidic channels from the micro channels.

In an embodiment, the carrier floating cover includes a regular hexagonal prism main body structure and a hemispherical top structure disposed on the regular hexagonal prism main body structure.

In an embodiment, surfaces of the regular hexagonal prism main body structure define multiple concave-convex type snap interfaces configured to splice the floating carrier with other floating carriers. The floating carriers splicing with each other realize a stable coverage over the water to be remediated.

In an embodiment, the inner bracket is a multi-layer partition frame structure disposed in the outer bracket, and the multi-layer partition frame structure defines the multiple carrying positions.

In an embodiment, each reagent filter cylinder is a cylinder structure provided with a filter mesh, and the water heavy metal removal reagents are disposed into each reagent filter cylinder. The inner bracket is provided with multiple support ribs disposed on each carrying position, each reagent filter cylinder is disposed on the support ribs on the respective carrying position, and the support ribs on the carrying positions are configured to support the reagent filter cylinders to make the inner bracket and the reagent filter cylinders together define the micro channels.

In an embodiment, each reagent filter cylinder is a cylindrical structure, a mesh section of the filter mesh of each reagent filter cylinder is trapezoidal, with a pore size in a range of 50 micrometers (μm) to 5 milliliters (mm), and the number of the reagent filter cylinders is adjusted according to the depth of the water to be remediated.

In an embodiment, an entrance diameter of each water flow channel on an outside of the outer bracket is between ⅕ of a maximum outer diameter of the carrier floating cover and an outer diameter of each reagent filter cylinder, and a smallest diameter at a middle part of each water flow channel is less than ½ of the entrance diameter. The microfluidic channel is connected to the micro channels, and an outlet of the microfluidic channel is connected to the middle parts of the water flow channels to achieve water inhalation through a venturi effect. A diameter of each microfluidic channel is in a range of 0.5 mm to 50 mm.

In a second aspect, the disclosure provides the method for removing the heavy metals from the water. The method includes following steps:
pre-process: detecting types and concentrations of the heavy metals in the water, and selecting and carrying water heavy metal removal reagents corresponding to the heavy metals;
carrier deployment: deploying the assembled floating carriers (i.e., the floating carriers splicing with each other) into the water to be remediated;
removal of the heavy metals from the water: sucking out water by using the negative pressure water absorption condition formed by each floating carrier, to allow contaminated water to contact the water heavy metal removal reagents for reaction and flow out after the reaction; and
agent recovery/replacement: recovering the floating carriers, replacing the water heavy metal removal reagents in the reagent filter cylinders of the floating carriers, and reusing the floating carriers after reloading.

In an embodiment, a particle size of each heavy metal removal reagent is greater than 60 μm to ensure effective filtration of the reagent filter cylinders.

In an embodiment, when deploying the floating carriers, only a part of each carrier floating cover is exposed above a water surface to prevent the floating carriers from stacking or stratifying.

Compared to the related art, the disclosure has the following benefits.

(1) In the disclosure, a narrow part of each water flow channel can form the venturi effect, thereby forming negative pressure inside the microfluidic channel, which allows the micro channels of the floating carrier to suck surrounding water, enhancing a remediation rate. The micro channels of the floating carrier also increase a contact area between the water heavy metal removal reagents and pollutants in the water, strengthening the remediation rate of the heavy metal removal reagents.

(2) In the disclosure, the floating carrier has a certain anti-pollution self-cleaning capability. The micro channels, due to a certain water flow rate, prevent small-diameter filter media from easily forming bridging and adhesion phenomena on a medium surface during operation, reducing a formation of filter cakes or blockages, thereby enhancing remediation efficiency of the heavy metal removal reagents.

(3) The disclosure has characteristics of simple form, large reagent contact area, and anti-fouling, which meets needs of heavy metal remediation in the water.

### BRIEF DESCRIPTION OF DRAWINGS

FIG. 1 illustrates a schematic structural diagram of a floating carrier for water heavy metal removal reagents of the disclosure.

FIG. 2 illustrates a schematic structural diagram of a reagent filter cylinder of the floating carrier of the disclosure.

FIG. 3 illustrates a schematic structural diagram of a microfluidic channel of the floating carrier of the disclosure.

FIG. 4 illustrates a schematic structural diagram of support ribs of the floating carrier of the disclosure.

FIG. 5 illustrates a schematic diagram of a mesh section of a filter mesh of the floating carrier of the disclosure.

Description of reference numerals: 1: carrier floating cover; 2: reagent filter cylinder; 3: water flow channel; 4: microfluidic channel; 5: filter mesh; 6: micro channel; 7: support rib; 8: outer bracket; 9: inner bracket; 10: concave-convex type snap interface; 11: hemispherical top structure; 12: regular hexagonal prism main body structure; 21: carrying position.

### DETAILED DESCRIPTION OF EMBODIMENTS

Overall, a floating carrier of the disclosure mainly includes a carrier floating cover, reagent filter cylinders, water flow channels, a microfluidic channel, filter meshes, micro channels, support ribs, an outer bracket and an inner bracket. The carrier floating cover is disposed at a top end, and a lower part of the carrier floating cover is connected to the outer bracket. The outer bracket defines the water flow channels and the microfluidic channel, and is provided with the support ribs inside. The reagent filter cylinders are provided with the filter meshes, and are horizontally disposed on the support ribs inside the inner bracket. The heavy metal removal reagents are disposed inside the reagent filter cylinders. The reagent filter cylinders and the inner bracket together define the micro channels which are ring-shaped. The disclosure is mainly applied in the field of water heavy metal remediation, especially suitable for washing remediation of heavy metal-contaminated paddy soils. A narrow part of each water flow channel can form a venturi effect, thereby forming negative pressure inside the microfluidic channel, which allows the micro channels of the floating carrier to suck surrounding water, increasing a contact area between the heavy metal removal reagents and pollutants in the water. Meanwhile, the micro channels, due to a certain water flow rate, can reduce a formation of blockages, thereby ensuring remediation efficiency of the heavy metal removal reagents. Compared to the related art, the disclosure has characteristics of simple form, large agent contact area, and anti-fouling, which meets needs of heavy metal remediation in the water.

The disclosure is described in detail below with reference to the accompanying drawings and specific embodiments. Any features such as component models, material names, connection structures, control methods and algorithms, etc., that are not explicitly stated in this technical solution are considered common technical features disclosed in the related art.

### Embodiment 1

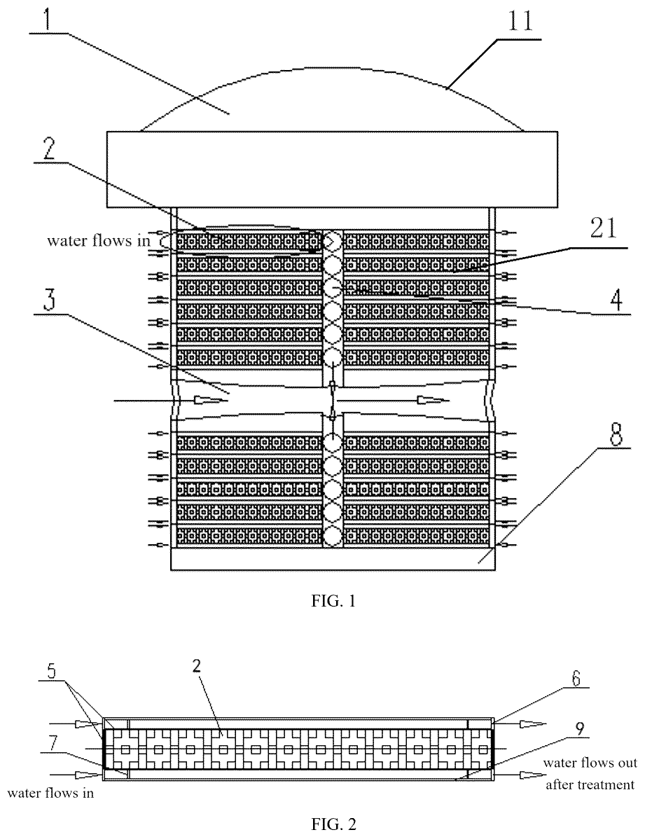

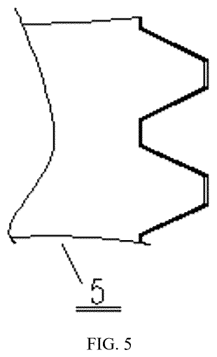

The embodiment provides a floating carrier for water heavy metal removal reagents and its application. The floating carrier mainly includes a carrier floating cover 1, reagent filter cylinders 2, water flow channels 3, a microfluidic channel 4, filter meshes 5, micro channels 6, support ribs 7, an outer bracket 8 and an inner bracket 9, as shown in FIG. 1. The carrier floating cover 1 is disposed at a top end, and a lower part of the carrier floating cover 1 is connected to the outer bracket 8. The outer bracket 8 defines the water flow channels 3 and the microfluidic channel 4, and the outer bracket 8 is provided with the support ribs 7 and the inner bracket 9 inside. The reagent filter cylinders 2 are provided with the filter meshes 5 and are horizontally disposed on the support ribs 7 inside the inner bracket 9. The heavy metal removal reagents are disposed inside the reagent filter cylinders 2. The reagent filter cylinders 2 and the inner bracket 9 together define the micro channels 6 which are ring-shaped, as shown in FIG. 2 and FIG. 4.

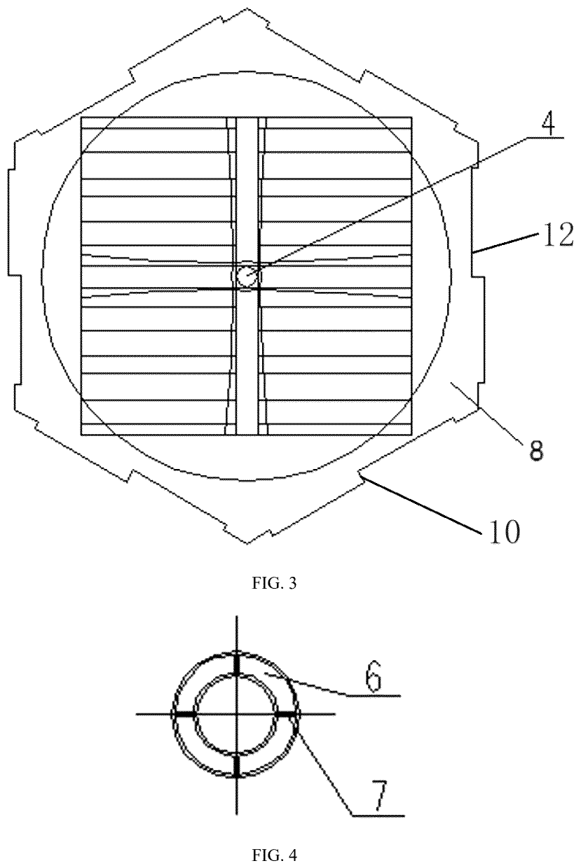

The carrier floating cover 1 includes a circular top and a regular hexagonal bottom structure (i.e., a regular hexagonal prism main body structure) 12, and the carrier floating cover 1 is made entirely of organic material and capable of floating in water. A top of the carrier floating cover 1 is a smooth hemispherical structure (i.e., a hemispherical top structure) 11. Since a gravity center of the floating carrier is located at a bottom of a gravity center of the carrier floating cover 1, the floating carrier stacked on it may freely slide into the water. Due to water flow fluctuations, a formation of a stacked structure can be prevented when multiple floating carriers are simultaneously put into the water. At the same time, each side of the regular hexagonal bottom structure 12 defines a concave-convex interface (i.e., a concave-convex type snap interface) 10, as shown in FIG. 3, which is configured to splice the multiple floating carriers. After being spliced, the multiple floating carriers achieve stable coverage of the water medium (i.e., the water) to be remediated.

Each reagent filter cylinder 2 is a cylinder structure provided with a filter mesh 5, and horizontally disposed inside the floating carrier. A mesh section of the filter mesh 5 of each reagent filter cylinder 2 is trapezoidal, as shown in FIG. 5, with smaller meshes at a part that contacts the water flow. Reagent particles accumulate inside the reagent filter cylinders 2, and the distribution of mesh sizes is related to a particle size of the reagents (i.e., the heavy metal removal reagents). A range of the mesh sizes is generally 50 μm to 5 mm. The number of the reagent filter cylinders 2 can be increased or decreased according to a depth of the water medium to be remediated. Each water flow channel 3 is located in a middle of the outer bracket 8, presenting a venturi tube structure that is large at both ends and small in a middle. An entrance diameter of each water flow channel 3 on an outside of the outer bracket 8 is not greater than ⅕ of a maximum outer diameter of the carrier floating cover 1, nor less than an outer diameter of each reagent filter cylinder 2. An inner hole diameter of each water flow channel 3 (i.e., a smallest diameter at the middle part of each water flow channel 3) is smaller than the entrance diameter, and less than ½ of the entrance diameter. The water flow channels 3 are connected to the microfluidic channel 4. Each surface of the floating carrier defines a water flow channel 3, and the number of the water flow channels 3 can be increased or decreased according to the actual number of the reagent filter cylinders 2 carried.

A width of each support rib 7 in contact with the micro channels 6 is in a range of 0.5 mm to 50 mm. The micro channels 6 are connected to the microfluidic channel 4.

The application of the floating carrier for the water heavy metal removal reagents, includes following steps (1) to (4).

(1) Pre-process: types and concentrations of heavy metals in the water are detected to obtain monitoring data, and heavy metal removal reagents are selected to be carried based on the monitoring data. A particle size of each heavy metal removal reagent is greater than 60 μm. The reagent filter cylinders 2 which are assembled is installed inside the inner bracket 8 of the floating carrier. According to an area and volume of the water medium to be remediated, multiple floating carriers are assembled based on above method in preparation for deployment into a specified water body.

(2) Carrier deployment: after transporting the assembled floating carriers to the water to be remediated, the floating carriers are deployed into the water. A reagent part of each floating carrier is submerged, only a part of the carrier floating cover 1 of each floating carrier is exposed above a water surface, and the floating carriers generally do not exhibit stacking or stratifying phenomena due to the distribution of the gravity center of each floating carrier and the smooth hemispherical structure 11 of the carrier floating cover 1 of each floating carrier.

(3) Removal of the heavy metals from the water: during a working process, the water flow passes through the water flow channels 3 and then form a certain negative pressure within the microfluidic channel 4 connected to the water flow channels 3. The negative pressure continuously sucks out the water through the micro channels 6, thereby ensuring that polluted water is constantly in contact with the heavy metal removal reagents in the reagent filter cylinders 2 for reaction. After the reaction, the water flows out, and the flowing water also carries away solid substances in the original water, prolonging the time before clogging occurs in the filter meshes 5.

(4) Agent recovery/replacement: the floating carriers scattered in the water are recovered by using tools such as boats or fishing nets. After recovery, the heavy metal removal reagents in the reagent filter cylinders of the floating carriers are replaced, and then the step (1) is repeated to the floating carriers so that the floating carriers can be reused.

### Application Embodiment 1

The floating carriers same as the embodiment 1 are used to remove cadmium from paddy soils (rice soils). Specific steps are as follows.

### (1) Pre-Process

A cadmium content in the paddy soils is 3.69 milligrams per kilogram (mg/kg), with a pH of 4.91, exceeding the corresponding risk screening values of the “Soil environmental quality-risk control standards for soil contamination of agricultural land (Trial)” (GB 15618-2018). The paddy field is irrigated and tillage equipment is used to plow the topsoil, enhanced remediation equipment is used to strengthen the desorption and leaching of the cadmium from the soils, followed by sedimentation for 3 hours to obtain overlying supernatant, a cadmium concentration is measured in the overlying supernatant.

The cadmium concentration in the overlying supernatant is about 37 micrograms per liter (μg/L). A molecular sieve with adsorption effects on the cadmium is selected as the remediation agent. The added agent particles have a particle size about 100 μm. The assembled reagent filter cylinders are installed inside a frame body of the floating carrier. The specific number of the reagent filter cylinders is determined based on the depth of the overlying supernatant in the paddy field irrigation water. According to the area of the paddy field to be remediated, it is calculated that approximately 300 floating carriers are needed.

### (2) Carrier Deployment and Paddy Soil Remediation

The floating carriers assembled are deployed into the paddy field to be remediated, aiming to remediate the paddy soils by removing heavy metals from the overlying supernatant.

### (3) Agent Recovery/Replacement

After approximately 4 days for remediation, the cadmium concentration in the overlying supernatant is reduced from 37 μg/L to 5 μg/L. The floating carriers scattered in the irrigation water supernatant are recovered. After recovery, the floating carriers only need to have the molecular sieve in the reagent filter cylinders replaced, and the pre-process operation repeated, and then wait for the next use.

The above description of the embodiments is for the convenience of those skilled in the art to understand and use the disclosure. Those skilled in the art can easily make various modifications to these embodiments and apply general principles described herein to other embodiments without the need for creative labor. Therefore, the disclosure is not limited to the above embodiments, and any improvements and modifications made by those skilled in the art based on the disclosure of the disclosure without departing from the scope of the disclosure should be within the scope of protection of the disclosure.

What is claimed is:

1. A floating carrier for water heavy metal removal reagents, comprising:
a carrier floating cover (1), with a hollow shell structure, wherein the carrier floating cover (1) is configured to provide buoyancy in water;
an outer bracket (8), disposed below the carrier floating cover (1);
an inner bracket (9), disposed in the outer bracket (8), wherein the inner bracket (9) defines a plurality of carrying positions (21);
a plurality of reagent filter cylinders (2), respectively disposed in the plurality of carrying positions (21), wherein the plurality of reagent filter cylinders (2) are configured to accommodate and support the water heavy metal removal reagents;
water flow channels (3), defined in a middle part of the outer bracket (8), wherein each water flow channel (3) is a venturi tube structure and configured to guide water flow through the floating carrier;
a microfluidic channel (4), defined within the outer bracket (8), wherein the microfluidic channel (4) is connected to the water flow channels (3), and configured to form a negative pressure water absorption condition to allow water in the microfluidic channel (4) to be sucked into the water flow channels (3); and
micro channels (6), defined on the inner bracket (9), wherein the micro channels are connected to the microfluidic channel (4) to allow part of water in the plurality of reagent filter cylinders (2) to be sucked into the micro channels (6) and to enter the microfluidic channel (4) from the micro channels (6).

2. The floating carrier for the water heavy metal removal reagents as claimed in claim 1, wherein the carrier floating cover (1) comprises a regular hexagonal prism main body structure (12) and a hemispherical top structure (11) disposed on the regular hexagonal prism main body structure (12).

3. The floating carrier for the water heavy metal removal reagents as claimed in claim 2, wherein surfaces of the regular hexagonal prism main body structure (12) define a plurality of concave-convex type snap interfaces (10) configured to splice the floating carrier with other floating carriers.

4. The floating carrier for the water heavy metal removal reagents as claimed in claim 1, wherein the inner bracket (9) is a multi-layer partition frame structure disposed in the outer bracket (8), and the multi-layer partition frame structure defines the plurality of carrying positions (21).

5. The floating carrier for the water heavy metal removal reagents as claimed in claim 4, wherein each reagent filter cylinder (2) is a cylinder structure provided with a filter mesh (5), and the water heavy metal removal reagents are disposed into each reagent filter cylinder (2); and
the inner bracket (9) is provided with a plurality of support ribs (7) disposed on each carrying position (21), each reagent filter cylinder (2) is disposed on the plurality of support ribs (7) on the respective carrying position, and the support ribs (7) on the plurality of carrying positions (21) are configured to support the plurality of reagent filter cylinders (2) to make the inner bracket (9) and the plurality of reagent filter cylinders (2) together define the micro channels (6).

6. The floating carrier for the water heavy metal removal reagents as claimed in claim 5, wherein each reagent filter cylinder (2) is a cylindrical structure, a mesh section of the filter mesh of each reagent filter cylinder (2) is trapezoidal, with a pore size in a range of 50 micrometers (μm) to 5 milliliters (mm), and a number of the plurality of reagent filter cylinders (2) is adjusted according to a depth of the water to be remediated.

7. The floating carrier for the water heavy metal removal reagents as claimed in claim 1, wherein an entrance diameter of each water flow channel (3) on an outside of the outer bracket (8) is between ⅕ of a maximum outer diameter of the carrier floating cover (1) and an outer diameter of each reagent filter cylinder (2), and a smallest diameter at a middle part of each water flow channel (3) is less than ½ of the entrance diameter;
the microfluidic channel (4) is connected to the micro channels (6), and an outlet of the microfluidic channel (4) is connected to the middle parts of the water flow channels (3) to achieve water inhalation through a venturi effect; and
a diameter of the microfluidic channel (4) is in a range of 0.5 mm to 50 mm.

8. A method for removing heavy metals from water by using the floating carrier as claimed in claim 1, comprising:
pre-process: detecting types and concentrations of the heavy metals in the water, and selecting and carrying water heavy metal removal reagents corresponding to the heavy metals;
carrier deployment: deploying the floating carriers which are assembled into the water to be remediated;
removal of the heavy metals from the water: sucking out water by using the negative pressure water absorption condition formed by each floating carrier, to allow contaminated water to contact the water heavy metal removal reagents for reaction and flow out after the reaction; and
agent recovery/replacement: recovering the floating carriers, replacing the water heavy metal removal reagents in the reagent filter cylinders of the floating carriers, and reusing the floating carriers after reloading.

9. The method for removing the heavy metals from the water as claimed in claim 8, wherein a particle size of each heavy metal removal reagent is greater than 60 μm to ensure effective filtration of the reagent filter cylinders.

10. The method for removing the heavy metals from the water as claimed in claim 8, wherein when deploying the floating carriers, only a part of the carrier floating cover (1) of each floating carrier is exposed above a water surface to prevent the floating carriers from stacking or stratifying.
